(19) United States
(12) Patent Application Publication
(10) Pub. No.: US 2012/0295044 A1
(43) Pub. Date: Nov. 22, 2012

(54) SHOCKPROOF COVER CUTTING STRUCTURE

(76) Inventor: Yaw Shin Liao, New Taipei City (TW)

(21) Appl. No.: 13/110,014

(22) Filed: May 18, 2011

(51) Int. Cl. B32B 1/08

(52) U.S. Cl. 428/35.2

(57) ABSTRACT

Disclosed is a shockproof cover cutting structure. At least one cutting line is provided between two air columns, wherein the cutting line is capable of separating the adjacent two air columns towards different directions, thereby allowing air column piece to be separated into two pieces and capable of rotating freely. Further, a through hole is disposed at top end of the cutting line where the two cutting lines of the two air columns intersect. When the two air columns are separated towards different directions, the through hole is capable of preventing the tearing point from extending linearly along the cutting line and ripping the air column thereof. Or, to prevent the column wall of the air column from being thinned and likely to be punctured by the object it is covering, causing air leakage and loss of cushioning function.

### BACKGROUND OF THE INVENTION

1. Field of the Invention

The present invention relates to an air column structure, and more particularly to a cutting structure for shockproof cover.

2. Brief Description of the Related Art

Existing cushion packaging method is to use air packing bag as the cushion material, wherein the air packing bag has two plastic films and an inner film with an air stop structure. The inner film thereof consists of two inner films and is disposed of an air inflation inlet; after air inflation, air column can be formed for air sealing. The air column is often required to bend with object's shape to cover the object completely and provide cushioning effect. Hence, hot melt point is often used to allow the air column to have turning point, and thereby being able to bend.

For instance, the prior art “An air-packing device,” patent number: U.S. Pat. No. 7,584,848, is described below.

An air-packing device inflatable by compressed air for protecting a product therein, comprising:

first and second thermoplastic films superposed with each other where predetermined portions of the first and second thermoplastic films are bonded, thereby creating a plurality of air containers;
a plurality of heat-seal lands each sealing the first and second thermoplastic films in a small area of the air container in a manner to allow air flow between the air cells, thereby creating a plurality of series connected air cells for each air container;
a plurality of check valves for corresponding air containers established between the first and second thermoplastic films for allowing the compressed air to flow in a forward direction; and
an air input commonly connected to the plurality of check valves to supply the compressed air to the air cells through the check valves;
wherein the air-packing device includes a body portion extending in a longitudinal direction and two flap portions at each end, the flap portions overlapping with the body portion, each flap portion including a first section extending from the body portion and a second section extending from the first section, wherein each flap portion including side edges extending in the longitudinal direction, the side edges of the first section being bonded to the body portion and the side edges of the second section being separate from the body portion.

Existing air column is separated into several sections by hot sealing line to allow bending thereof. However, when the air column needs to turn over towards the back or reverse, the separator bar therebetween is used for cutting the two air columns apart, allow them to reverse respectively after being separated, and thereby increasing the applicable area thereof. In this case, the characteristic of plastic material is very likely to tear the air column forward on the straight line direction rather than rip the air column directly. Or, the column wall of the air column is thinned and is very likely to be punctured by the object it is covering, causing air leakage and loss of cushioning function.

### SUMMARY OF THE INVENTION

In order to overcome the deficiencies of the prior art, a primary object of the present embodiment is to provide a cutting structure for shockproof cover that is capable of preventing tearing point to extend linearly along a cutting line between air columns. The shockproof cover cutting structure of the embodiment includes at least one cutting line between two air columns, wherein the cutting line is capable of separating the adjacent two air columns towards different directions, thereby allowing air column piece to be separated into two pieces and being able to rotate freely. Further, a through hole is disposed at the top end of the cutting line where the two cutting lines of the two air columns intersect. When the two air columns are separated towards different directions, the through hole is capable of preventing the tearing point from extending linearly along the cutting line and ripping the air column thereof. Or, to prevent the column wall of the air column from being thinned and likely to be punctured by the object it is covering, causing air leakage and loss of cushioning function. Hence, air column piece should be presented in other pattern.

Another object of the present embodiment is to increase the thickness of the shockproof cover cutting structure and enhance the strength of the shockproof cover cutting structure. Also, the through hole of the shockproof cover cutting structure of the present embodiment has enhanced tear resistance thereof. The shockproof cover cutting structure has at least one strengthening layer attaching to any one side of or both sides of the air column piece; wherein, the strengthening layer can be made of nonwoven fabric. Moreover, since the strengthening layer is tightly attached to the air column piece, the thickness of the shockproof cover cutting structure is increased and the strength thereof is enhanced, thereby preventing the cutting line from further tearing and extending.

### BRIEF DESCRIPTION OF THE INVENTION

The detail structure, the applied principle, the function and the effectiveness of the present invention can be more fully understood with reference to the following description and accompanying drawings, in which:

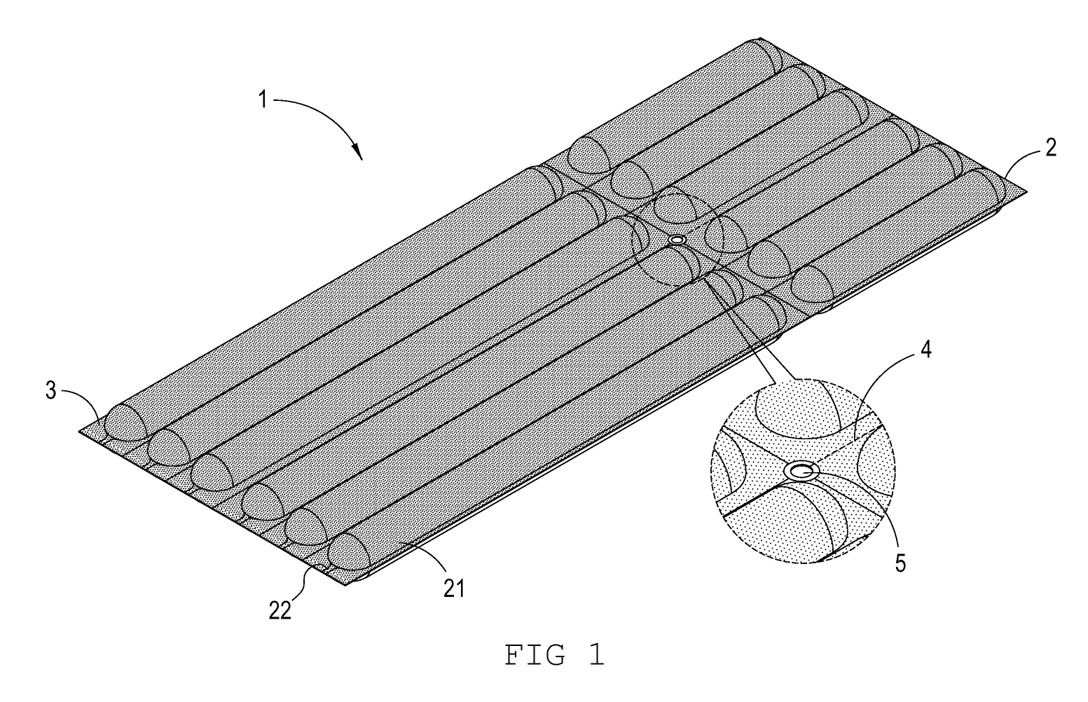

FIG. 1 is an appearance perspective view according to the present invention;

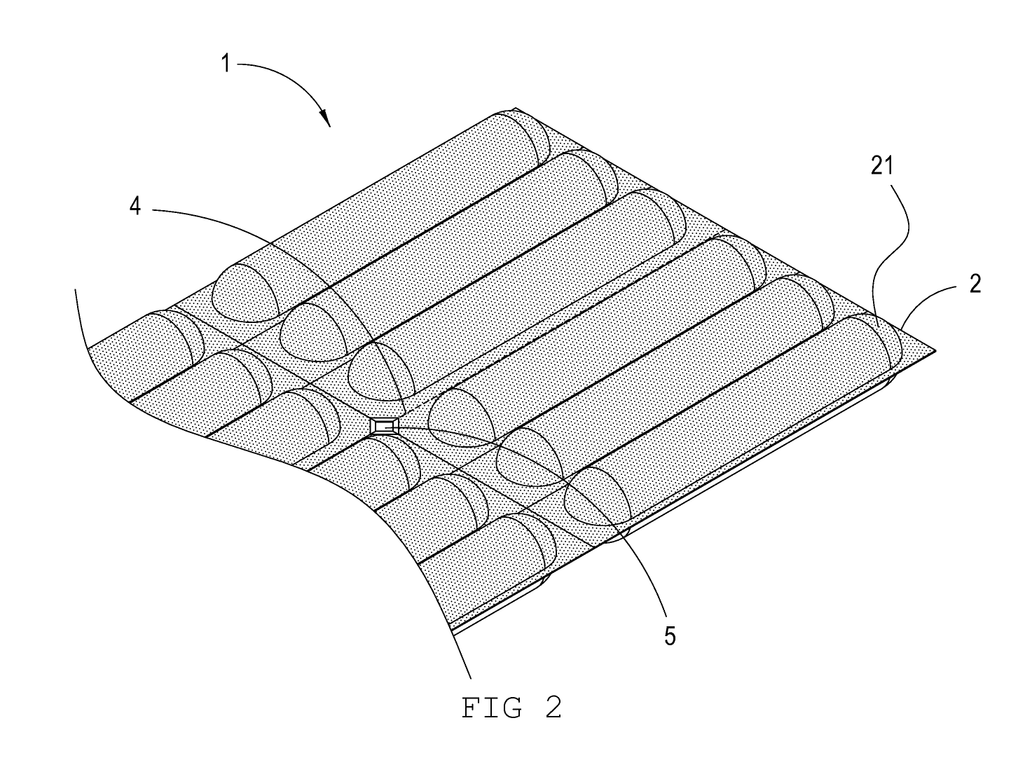

FIG. 2 is a partial schematic view according to the present invention;

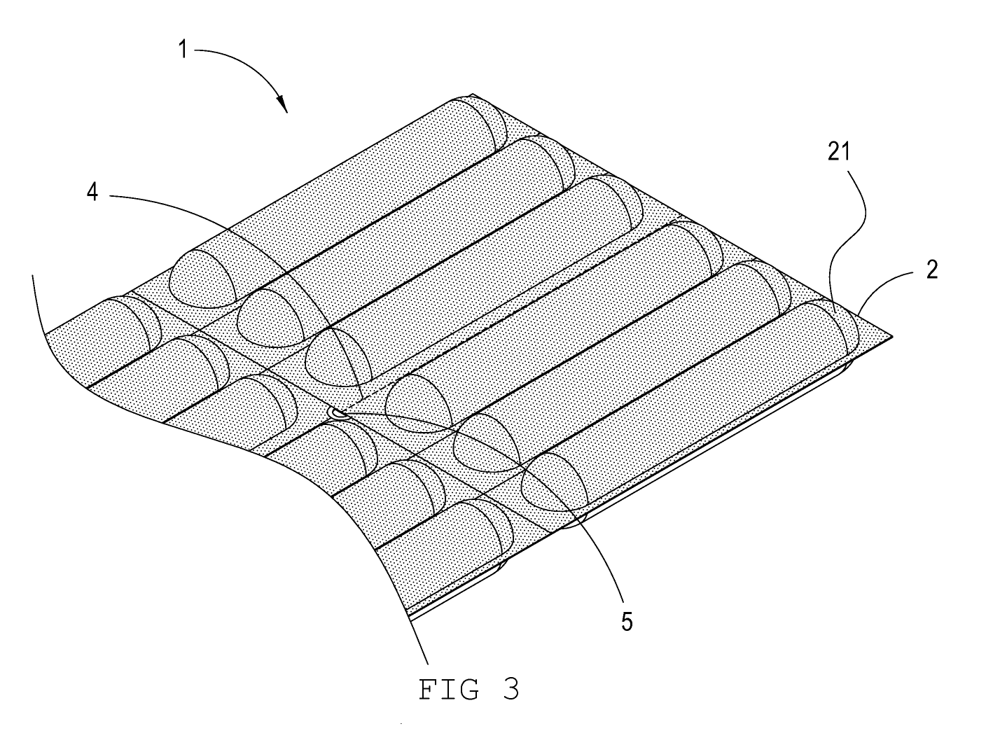

FIG. 3 is the first view of the preferred embodiment according to the present invention;

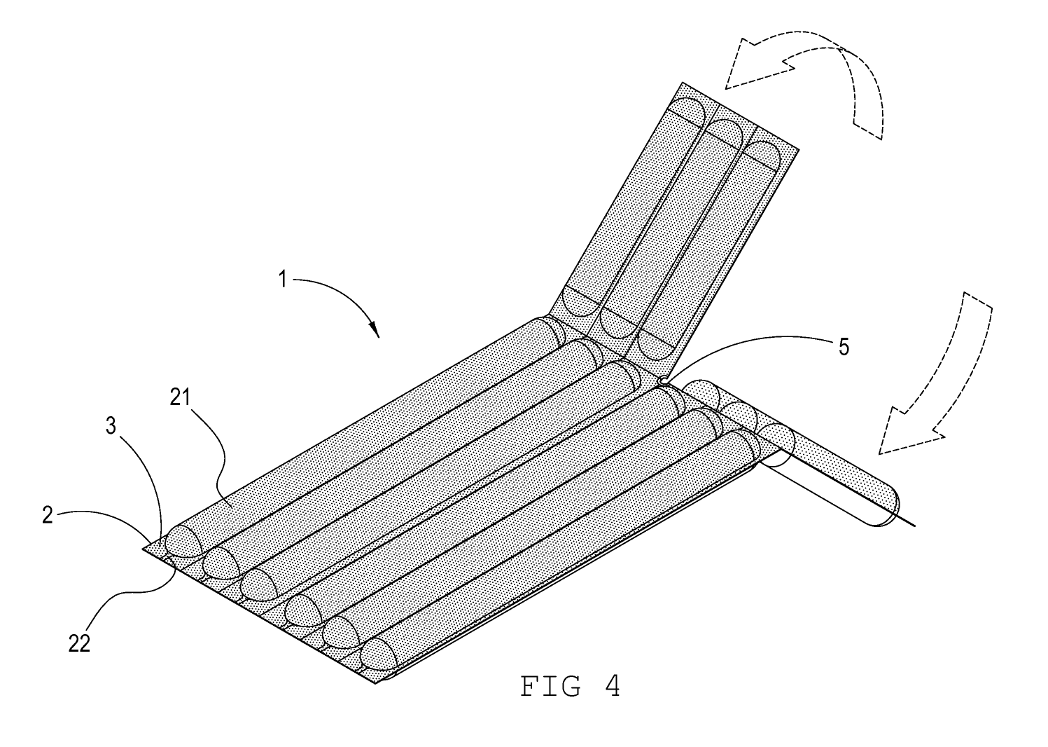

FIG. 4 the second view of the preferred embodiment according to the present invention;

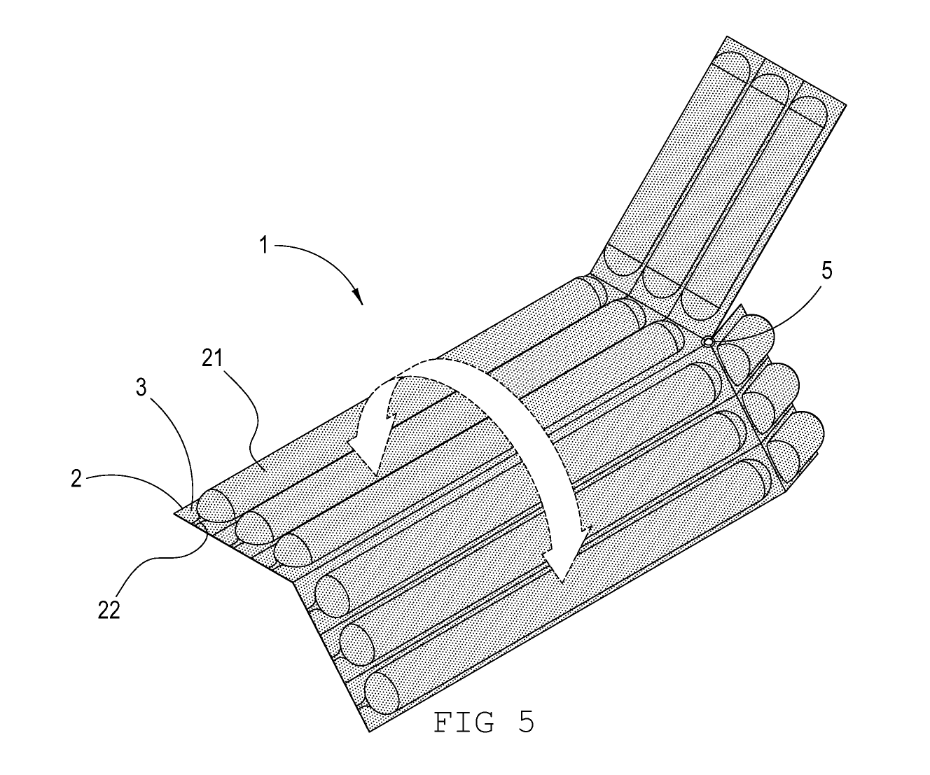

FIG. 5 the third view of the preferred embodiment according to the present invention; and

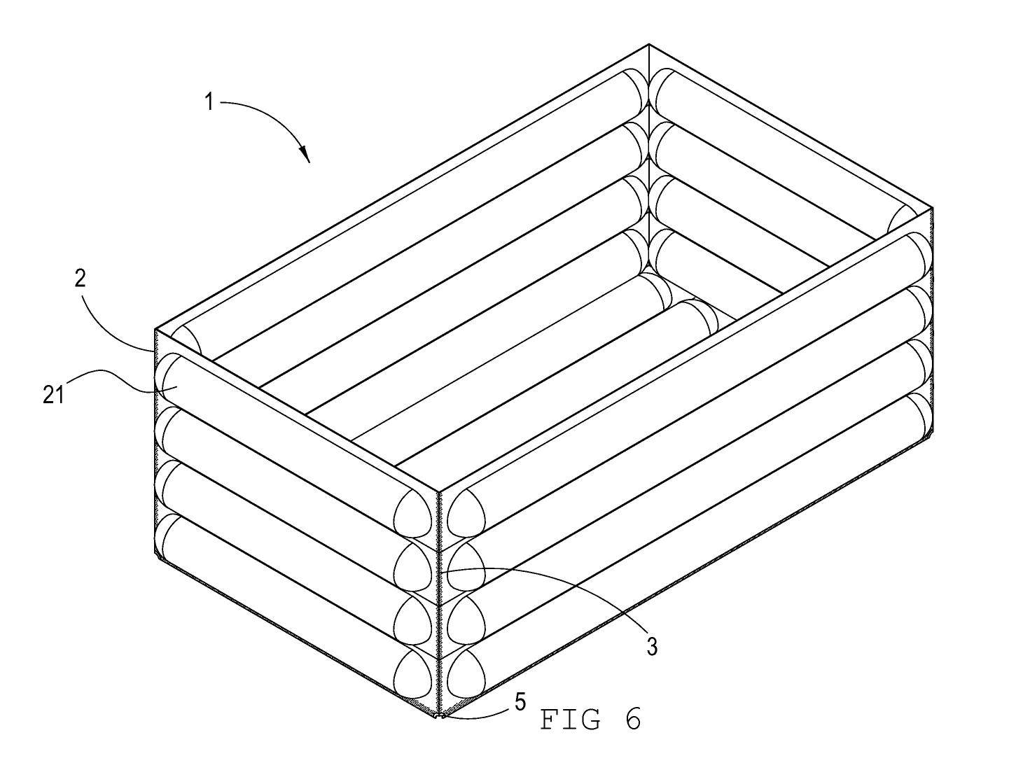

FIG. 6 the fourth view of the preferred embodiment according to the present invention.

### DETAILED DESCRIPTION OF THE PREFERRED EMBODIMENTS

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

Please refer to FIGS. 1 to 6 first, which illustrate the appearance perspective view, partial schematic view and preferred embodiment of the present invention. A shockproof cover cutting structure 1 is provided therein, which includes: an air column piece 2 parallel consists of a plurality of air columns 21, each of the air columns 21 is disposed of an air inflation inlet 22, and by the air inflation inlet 22 it is able to inflate the plurality of air columns 21 to form a cushion packaging effect and protect an object covered therein;

a strengthening layer 3 attached to any one side of or both sides of the air column piece 2, or can be disposed at a specific position to enhance the strength of that specific position of the air column piece 2; further, the strengthening layer 3 may be made of nonwoven fabric;
at least one cutting line 4 provided between the two air columns 21 and is capable of separating the two adjacent air columns 21 towards different directions, thereby allowing air column piece 2 to be separated into two pieces and capable of rotating freely, and wherein, the cutting line 4 is capable of allowing the two adjacent air columns 21 to rotate upwards or downwards for 90 degrees using a through hole 5 as a rotate center, or allowing the two adjacent air columns 21 to rotate to the left or to the right for 90 degrees using the through hole 5 as a rotate center; and
the through hole 5 disposed at a top end of the cutting line 4, wherein the through hole 5 may be of a rounded shape, a semicircular shape, or a square shape; if the through hole 5 is of a rounded shape, a rivet opening will be formed by the through hole 5 and the cutting line 4; if the through hole 5 is semicircular in shape, a mushroom-shaped opening will be formed by the through hole 5 and the cutting line 4; and if the through hole 5 is shaped like a square, a T shape will be formed by the through hole 5 and the cutting line 4.

When the two air columns 21 are separated toward different directions, a tearing point will be formed on the cutting line 4 between the two air columns 21, and since the air column 21 is made of plastic material and may be ripped if the tearing continues, the through hole 5 is designed to prevent the tearing point from extending linearly along the cutting line 4 and ripping the air column thereof, or to prevent the column wall of the air column 21 from being thinned and being likely to be punctured by the covered object, which may cause air leakage and loss of cushioning function. Further, the strengthening layer 3 is tightly attached to the air column piece 2, hence the thickness of the shockproof cover cutting structure 1 is increased and the strength thereof is enhanced, thereby preventing the cutting line 4 from further tearing and extending.

Since the two air columns 21 is made of plastic material, a tearing point or a notch thereof is very likely to be extended along the end point. Therefore, the shockproof cover cutting structure 1 may easily solve the problems of the air column 21 being tore forward on the straight line direction or the column wall of the air column 21 being thinned and easily get punctured by the object it is covering, which causes air leakage and loss of cushioning function. The shockproof cover cutting structure 1 of the present embodiment has increased thickness thereof to prevent the cutting line 4 from moving towards wrong position or direction, and also to prevent the tearing point from extending linearly along the cutting line 4. The method of the embodiment is described hereinafter.

An air column piece 2 of the size 70 cm×70 cm has 16 air columns 21. The air column piece 2 is folded to form two layers of air column piece 2, each layer having 8 air columns 21 and is of the size 70 cm×35 cm. Piling together the first air column 21, the second air column 21, the third air column 21 and the fourth air column 21 of the first layer to the first air column 21, the second air column 21, the third air column 21 and the fourth air column 21 of the second layer, and then hot seal them together. Cutting a 20 cm cutting line 4 along each of two ends of the fourth air columns 21 and the fifth air columns 21 respectively, each of the cutting lines 4 has a rounded through hole 5 disposed thereon. A strengthening layer 3 is attached to the front surface of the air column piece 2 and is disposed at the same side as the cutting line 4. The fifth air column 21, the sixth air column 21, the seventh air column 21 and the eighth air column 21 may bend along the cutting line 4, allowing the fifth air column 21, the sixth air column 21, the seventh air column 21 and the eighth air column 21 to insert into the first air column 21, the second air column 21, the third air column 21 and the fourth air column 21. A cushioning box body may be formed thereof after air inflation. The rounded through hole 5 is capable of preventing the tearing point from extending linearly along the cutting line 4 and ripping the air column 21 thereof. Further, the strengthening layer 3 is tightly attached to the air column piece 2, hence the thickness of the shockproof cover cutting structure 1 is increased, thereby preventing the cutting line 4 from further tearing and extending.

What is claimed is:

1. A shockproof cover cutting structure comprising:
an air column piece parallel consists of a plurality of air columns, each of the air columns is disposed of an air inflation inlet;
a strengthening layer attached to any one side of or both sides of the air column piece, and may be made of nonwoven fabric;
at least one cutting line provided between the two adjacent air columns capable of separating the two adjacent air columns toward different directions, thereby allowing air column piece to be separated into two pieces and capable of rotating freely; and
a through hole disposed at a top end of the cutting line, wherein the through hole may be of a rounded shape, a semicircular shape, or a square shape;
wherein, when the two air columns are separated toward different directions, a tearing point may be formed on the cutting line between the two air columns, and the through hole is capable of preventing the tearing point from extending linearly along the cutting line and ripping the air column thereof, or the column wall of the air column from being thinned and being likely to be punctured by a covered object, which may cause air leakage and loss of cushioning function; further, the strengthening layer is tightly attached to the air column piece, hence the thickness of the shockproof cover cutting structure is increased and the strength thereof is enhanced, thereby preventing the cutting line from further tearing and extending.

2. A shockproof cover cutting structure comprising:
an air column piece parallel consists of a plurality of air columns, each of the air columns is disposed of an air inflation inlet, and after folding the air column piece, ends of at least one air column are hot sealed together;
a strengthening layer attached to any one side of or both sides of the air column piece, and may be made of nonwoven fabric;
at least one cutting line provided between the air column with ends hot sealed together and air column without ends hot sealed together, wherein the cutting line is capable of separating the two adjacent air columns toward different directions, thereby allowing air column piece to be separated into two pieces and capable of rotating freely; and
a through hole disposed at a top end of the cutting line, wherein the through hole may be of a rounded shape, a semicircular shape, or a square shape;
wherein, when the air column piece is folded to form two layers of air column piece, ends of a first layer air columns and ends of a second layer air columns are piled and hot sealed together, and then the air columns are inserted into the air column piece and inflated to form a cushioning box body with no upper cover thereon.

3. The shockproof cover cutting structure as defined in claim 1, wherein a rivet opening will be formed by the through hole and the cutting line when the through hole is rounded in shape.

4. The shockproof cover cutting structure as defined in claim 1, wherein a mushroom-shaped opening will be formed by the through hole and the cutting line when the through hole is semicircular in shape.

5. The shockproof cover cutting structure as defined in claim 1, wherein a T shape will be formed by the through hole and the cutting line when the through hole is shaped like a square.

6. The shockproof cover cutting structure as defined in claim 1, wherein the cutting line is capable of allowing the two adjacent air columns to rotate upwards or downwards for 90 degrees taking the through hole as a rotate center.

7. The shockproof cover cutting structure as defined in claim 1, wherein the cutting line is capable of allowing the two adjacent air columns to rotate to the left or to the right for 90 degrees taking the through hole as a rotate center.

8. The shockproof cover cutting structure as defined in claim 1, wherein the strengthening layer may be attached to a specific region to enhance the strength of the specific region.

9. The shockproof cover cutting structure as defined in claim 2, wherein a rivet opening will be formed by the through hole and the cutting line when the through hole is rounded in shape.

10. The shockproof cover cutting structure as defined in claim 2, wherein a mushroom-shaped opening will be formed by the through hole and the cutting line when the through hole is semicircular in shape.

11. The shockproof cover cutting structure as defined in claim 2, wherein a T shape will be formed by the through hole and the cutting line when the through hole is shaped like a square shape.

12. The shockproof cover cutting structure as defined in claim 2, wherein the cutting line is capable of allowing the two adjacent air columns to rotate upwards or downwards for 90 degrees taking the through hole as a rotate center.

13. The shockproof cover cutting structure as defined in claim 2, wherein the cutting line is capable of allowing the two adjacent air columns to rotate to the left or to the right for 90 degrees taking the through hole as a rotate center.

14. The shockproof cover cutting structure as defined in claim 2, wherein the strengthening layer may be attached to a specific region to enhance the strength of the specific region.
